(19) United States
(12) Patent Application Publication
(10) Pub. No.: US 2007/0041548 A1
(43) Pub. Date: Feb. 22, 2007

(54) Automatic voice system integration

(75) Inventors: Joann J. Ordille, South Orange, NJ (US); Scott A. Schell, Westminster, CO (US); John Hamilton Slye, Bridgewater, NJ (US); Bruce E. Walsh, Londonderry, NH (US)

Correspondence Address: MCGRATH, GEISSLER, OLDS & RICHARDSON, PLLC, PO BOX 1364, FAIRFAX, VA, 22038-1364, US

(73) Assignee: Avaya Technology Corp.

(21) Appl. No.: 11/446,105

(22) Filed: Jun. 5, 2006

Related U.S. Application Data
(60) Provisional application No. 60/686,936, filed on Jun. 3, 2005.

(51) Int. Cl. H04M 3/42

(52) U.S. Cl. 379/202.01

(57) ABSTRACT

A server or servers and a method of operating a server or servers to establish a conference call includes determining parties to be joined into a conference call, notifying the parties about the conference call, authenticating parties that responded to the notification about the conference call, and bridging the parties that have been successfully authenticated into the conference call.

The present invention claims the benefit of U.S. provisional application Ser. No. 60/686,936, filed on Jun. 3, 2005, which is hereby incorporated by reference in its entirety.

### BACKGROUND OF THE INVENTION

1. Field of the Invention

The present invention relates to conference calling, and more particularly to a robust conference calling method and system that integrates conference bridging, notification and Interactive Voice Response (IVR) subsystems.

2. Discussion of the Related Art

Conference calling is currently used by many companies or businesses, as well as individual users, to bridge several users into a single call. For example, a large company may have employees dispersed throughout the United States and want to conduct a meeting via a conference call. To do this, an email is generally sent to all relevant employees about when the conference is scheduled. At the time of the conference, the individual employees can be notified by dialing them from a conference bridge or the individual employees can call into the conference bridge.

That is, this notification process is initiated via human driven communication. However, it is cumbersome when the meeting is part of a business process or exceptional event such as an emergency or unplanned event. Also, standard mechanisms are very inefficient when trying to quickly assemble a meeting with the appropriate people to deal with an emergency.

Further, this notification process is cumbersome and time consuming. In addition, the only way to determine whether the notified person is going to attend is via an email or telephone call from the respective persons. There is also no way to determine that the person notified is actually the person wanted in the conference meeting. For example, the email is sent to a particular computer, but there is no way to verify that the person responding to the email is actually the intended recipient. In addition, there is not a centralized location or server where each notified person can view and manage particular conference tasks. This is particularly disadvantageous when multiple conference calls are scheduled in a single day or short time period. Thus, the related art conference system still uses archaic means for scheduling, notifying and conducting conference calls.

### SUMMARY OF THE INVENTION

Accordingly, one object of the present invention is to address the above noted and other problems.

Another object of the present invention to provide an integrated conference bridging method and system that efficiently notifies the intended parties.

Yet another object of the present invention is to accurately identify or verify the intended party joining the conference call.

Still another object of the present invention it to provide intended parties with a centralized platform so they can view and manage scheduled conference calls.

To achieve these and other advantages and in accordance with the purpose of the present invention, as embodied and broadly described, there is provided a conference calling method, which includes determining parties to be joined into a conference call, notifying the parties about the conference call, authenticating parties that responded to the notification about the conference call, and bridging the parties that have been successfully authenticated into the conference call. The present invention also provides a corresponding conference calling system and computer program product.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is an overview of an integrated conference bridging system in accordance with the present invention;

FIG. 2 is flowchart of a conference bridging method in accordance with the present invention;

FIG. 3 is a flowchart of a conference notification method in accordance with the present invention;

FIG. 4 is a flowchart of a conference authentication method in accordance with the present invention;

FIG. 5A is a web page illustrating a conference calling management platform in accordance with the present invention; and

FIG. 5B is a web page illustrating details regarding a specifically scheduled conference call.

### DETAILED DESCRIPTION

Reference will now be made in detail to the preferred embodiments of the present invention, examples of which are illustrated in the accompanying drawings.

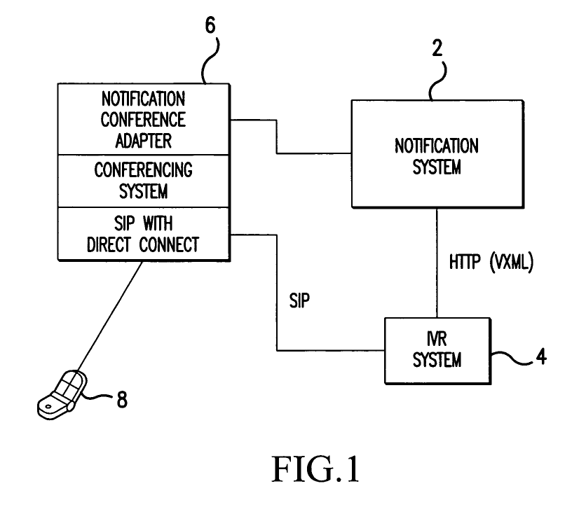

Turning first to FIG. 1, which is an overview of an integrated conference bridging system in accordance with the present invention. As shown, the conference bridging system includes a notification server 2, an IVR server 4, a conference bridging server 6 and a user or party 8. The servers are shown as being separate servers in FIG. 1, but it is also possible to include the functions of the servers in a single server. In addition, for simplicity purposes only one party 8 is shown in FIG. 1.

Thus, the conference calling system in accordance with the present invention integrates the notification server 2, the IVR server 4 and the conference bridging server 6 into a single conference calling system. In addition, the notification server 2 notifies the intended parties about a conference call. The server 2 also provides a conference calling management platform (e.g., a web page) that can be accessed by the respective parties to manage their different conference calls and other related information. The IVR server 4 authenticates the parties and performs other interactive voice response services, and the conference bridging server 6 bridges the different parties into the conference call. Further, as shown, the conference bridging server 6 includes a notification conference adapter, a conference system and a Session Internet Protocol (SIP) for communicating with the party 8.

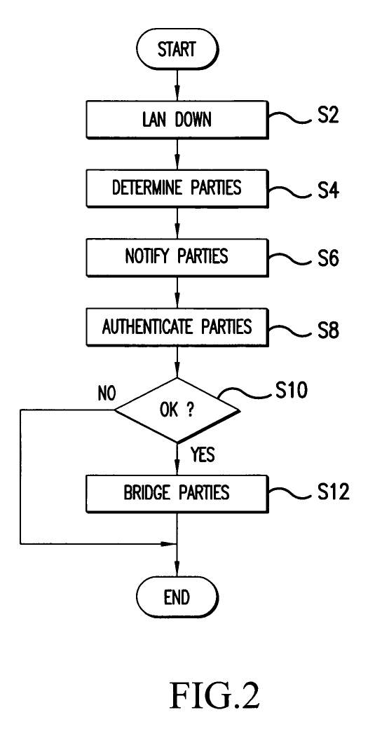

Turning next to FIG. 2, which is flowchart of a conference bridging method in accordance with the present invention. FIG. 1 will also be referred to when describing the following figures. In more detail, FIG. 2 illustrates an example where a Local Area Network (LAN) at a company is down, and the appropriate parties are bridged into a conference call to discuss the matter. However, the conference calling method in accordance with the present invention also applies to any other example that requires a conference call.

As shown in FIG. 2, a LAN has been determined to be in a DOWN state (step S2) and the appropriate parties to contact are determined in step S4. The LAN may be determined as being in a DOWN state based on status values maintained by a computer monitoring a router connected to the LAN. Thus, when the status values indicate the LAN is down, the conference calling method of the present invention determines the appropriate people to contact.

For example, the appropriate people may be employees of a computer department (in-house or external contractors), a manager of the department the LAN went down in, and any other relevant persons that need to be bridged into a conference call to address the issue. In addition, the relevant parties may be stored in a centralized database or may be searched or queued to determine the appropriate parties. For example, a database may include a list of appropriate persons to be contacted in the event of a network failure and this list is then accessed when the network fails.

Alternatively, an employer database may be searched to determine the appropriate parties to contact. That is, in the example shown in FIG. 2, the employer database may be searched for “Computer Department” and then those identified persons are notified. The search may also be further defined to indicate employees in the computer department who are responsible for that particular LAN, and/or employees that are available at particular times during the day (e.g., after midnight), etc. Managers responsible for the department where the LAN is down may also be included in the list. Thus, in accordance with the present invention, the appropriate parties that need to be contacted can be automatically determined without user intervention. This advantageously reduces the amount of time required to begin addressing the issue of the LAN being down.

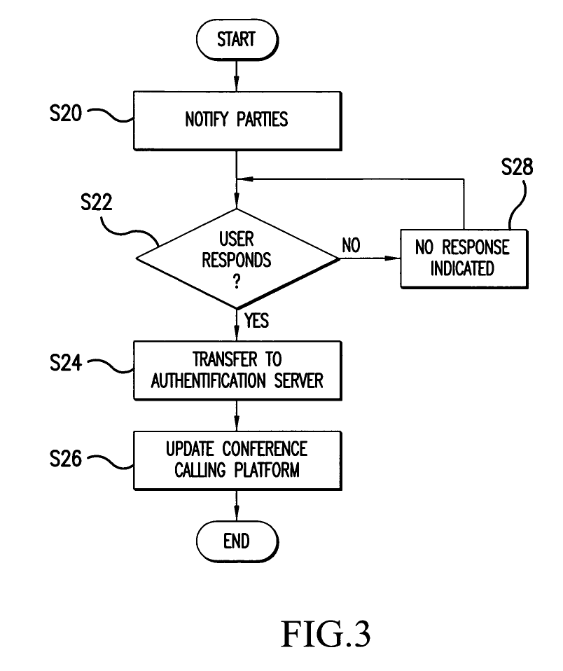

After the appropriate parties are determined, control is passed to the notification server 2. The notification server 2 then notifies the parties (step S6). For example, the list of determined parties includes information such as a telephone number, pager number, email address, etc. for each particular party. The notification server 2 then uses this information to notify each relevant party. The notification process is discussed in more detail with respect to FIG. 3.

In addition, as discussed above, the present invention also provides a web page/conference calling management platform where each party may access information regarding their respective scheduled conference calls and other related information. Further, through this web page, the particular party can also update their telephone number, pager number, email address, available hours, etc. This is particularly advantageous because employees that are traveling, for example, can leave a number at a hotel or any other number.

In addition, with reference to FIG. 2, when the appropriate parties are notified and a party responds to the notification (e.g., by answering the phone call, by calling back into the system, by responding via email, etc.), the control is passed to the IVR server 4 that authenticates the party (step S8). The authentication process can be simply the user entering an ID and password (e.g., by speaking into the phone or entering the information via the keys on the phone) or may include a voice authentication process. That is, the user may be requested to state his or her name, and then the voice authentication process compares his voice with a previously recorded voice portion of the party.

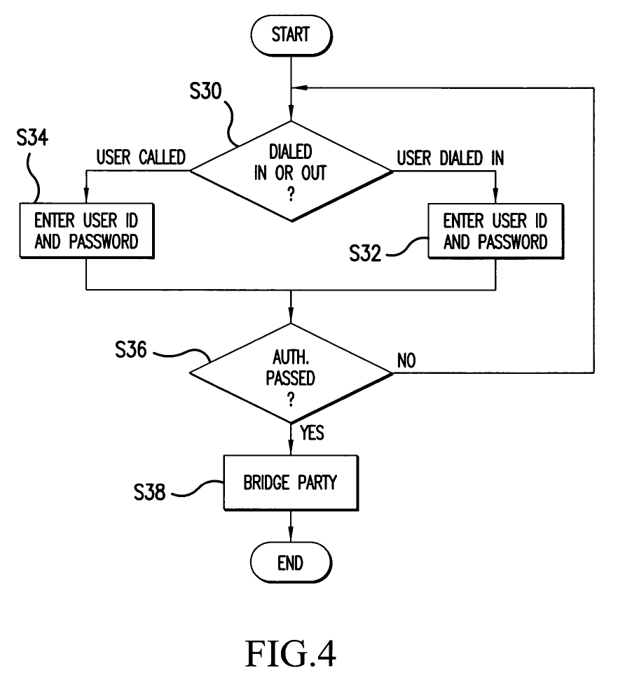

The authentication process then determines whether or not the party is the correct party (step S10). If the party is not properly authenticated (No in step S10), they are not given access to the system. However, the user can call back later with the proper authentication credentials and be given access. If the party is properly authenticated (Yes in step S10), they are able to hear information about the meeting or other notifications. They are then given an opportunity to join the conference. Next, the control of the process regarding that particular user is then passed to the conference bridging server 6. The bridging server 6 then adds the authenticated party to the conference call at the appropriate time (step S12). The authentication process is discussed in more detail with respect to FIG. 4.

In addition, the appropriate parties may be determined, and notified well before the conference call is actually performed. In this instance, a supplemental authorization process may be performed, if necessary. Alternatively, each respective party may be immediately bridged into the conference call after they have been authenticated.

Next, FIG. 3 is a flowchart of the notification method in accordance with the present invention. As discussed above, the appropriate parties, which were previously determined, are notified via telephone, email, pager, Instant Message (IM), etc. (step S20). The notification method then determines whether or not the notified party has responded (step S22). For example, the user may respond by answering the telephone, pager or IM, or by replying to an email. If the user does not respond to the notification (No in step S22), the notification server 2 updates the web page to reflect the user has not responded (step S28). This is particularly advantageous because all relevant parties can then view who has responded.

In addition, if the party responds to the notification (Yes in step S22), the control for that particular party is passed to the IVR server 4 to be authenticated (step S24). The conference calling management platform is also updated to reflect that the party is currently being authenticated (step S26). Again, this is convenient for other parties because they can determine the overall state of the conference call by simply viewing the web page.

Turning now to FIG. 4, which is a flowchart of the authentication method in accordance with the present invention. As shown, the authentication method first determines whether the notification server 2 called the party or whether the party called into the system (step S30). This information can be passed to the IVR server 4. If the party was called, the user need only enter a password (step S34). That is, because the user was called, the number or ID of the user is already known.

Alternatively, if the party called into the system after being notified, the IVR server 4 requests the party enter an ID and password (step S32). The IVR server 4 then determines whether the party is authenticated (step S36). That is, the IVR server 4 can check a database of existing user Ids/passwords or use voice recognition techniques. Other authentication procedures may also be used (e.g., only authenticating users who call from a particular “red” emergency phone).

Further, if the party has been successfully authenticated, the web page is updated to indicate the party is going to attend the conference. This is particularly advantageous if one party need only attend if a particular other party attends. That is the one party can wait to respond until the other party is confirmed as attending the conference call.

If the party has not been successfully authenticated (No in step S36), the party is not given access to the system. However, the party may call back later into the system when he or she has the correct authentication information and the process starts again at step S30.

In addition, in an alternative embodiment of the present invention, the method may also update the web page to indicate that a respective user has not been successfully authenticated. Thus, when a party fails to be properly authenticated, the other parties can view the web page and determine that perhaps someone is illegally trying to enter the conference call or is having problems (forgot their password, etc). This is beneficial for particularly sensitive conference calls such as a conference call about an opening price of to be released shares of stocks. In addition, if the user successfully passes the authentication process (Yes in step S36), the control for that particular user is passed to the conferencing bridging server 6 (step S38). At this point, the party is either immediately brought into the conference call, placed on hold until the scheduled conference call time. Alternatively, the party may call, or be called, at the scheduled conference call time and pass through the authentication process again.

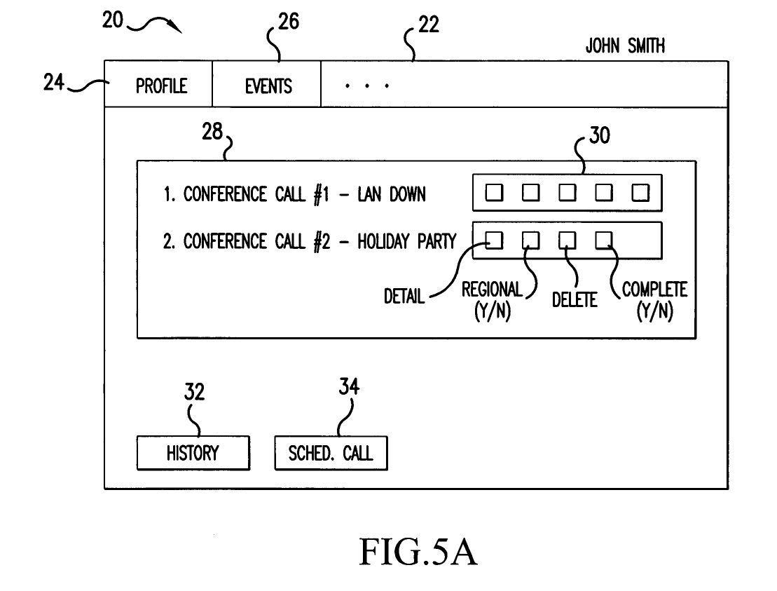

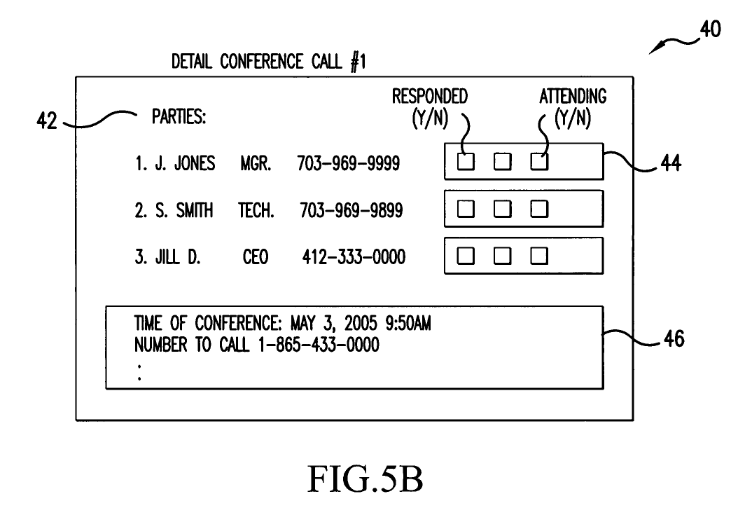

Next, FIGS. 5A and 5B illustrate the conference calling management platform in accordance with the present invention. The web page may reside on any one of the servers discussed above or may reside on a separate server. Further, the users/parties can access the web page by entering an appropriate Internet address. In more detail, FIG. 5A illustrates a main web page 20 that is displayed on the user's computer after first logging in. As shown, the web page 20 includes a plurality of fields such as a main menu bar 22 including a profile button 24 and events button 26. The web page 20 also includes a main window 28 including a list of current events (e.g., conference calls), and a status/reply section 30 including different radio buttons the user can select or view. The main web page 20 also includes a history button 32 and a schedule conference call button 34.

Thus, with reference to FIG. 5A, the user can select the profile button 22 to update his or her personal information, such as a phone number to be reached at, availability hours, etc. This feature can also be used to update or change his or her password that is used by the authentication method. The user may also select the events button 26 to list all events in the main display window 28. As shown in FIG. 5A, the user John Smith has two conference calls.

In addition, the radio buttons in the status/reply section 30 include, for example, a detail radio button, a respond radio button, a delete radio button and a completed status radio button. The detailed radio button may be selected to get more detailed information about the particular conference call, the respond radio button may be selected to respond to the notification request, the delete button may be selected to delete the particular conference call from the events window 28, and the completed status radio button indicates whether or not the conference call has been completed.

As discussed above, the main display window 20 also includes the history button 32 and the schedule call button 34. The history button 32 may be selected to view a history (e.g., last week, last month, last year) of all conference calls. This is useful when the particular party needs to prepare a performance report, for example, and thus can use this information to remember particular conference calls that previously occurred. The user may also select the schedule call button 34 to schedule a conference call. In this instance, another window is displayed requesting the user to enter all parties to be notified, subject matter, time, phone numbers, etc.

Next, FIG. 5B illustrates a detailed main window 40 that is displayed when the user selects the detailed radio button in the status/reply section 30. As shown, the main window 40 includes information 42 about the parties that may attend the conference call, a sub window 46 including information about the time of the conference call, the number to call, etc. and a status window 44 including status information about the particular conference. The status window 44 includes radio buttons such as a responded radio button indicating whether the particular party has responded to the notification, and an attending radio button indicating whether the particular party is going to attend the conference call. Thus, the user is able to view more detailed information about the conference call.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The servers and other portions of this invention may be conveniently implemented using a conventional general purpose digital computer or microprocessor programmed according to the teachings of the present specification, as will be apparent to those skilled in the computer art. Appropriate software coding can readily be prepared by skilled programmers based on the teachings of the present disclosure, as will be apparent to those skilled in the software art. The servers and other portions of this invention may also be implemented by the preparation of application specific integrated circuits whereby interconnecting an appropriate network of conventional computer circuits, as will be readily apparent to those skilled in the art.

Any portion of the present invention implemented on a general purpose digital computer or microprocessor includes a computer program product which is a storage medium including instructions which can be used to program a computer to perform a process of the invention. The storage medium can include, but is not limited to, any type of disk including floppy disk, optical disk, CD-ROMs, and magneto-optical disks, ROMs, RAMs, EPROMs, EEPROMs, magnetic or optical cards, or any type of media suitable for storing electronic instructions.

What is claimed is:

1. A method of operating a server or servers to establish a conference call comprising:
determining parties to be joined into a conference call;
notifying the parties about the conference call;
authenticating parties that responded to the notification about the conference call; and
bridging the parties that have been successfully authenticated into the conference call.

2. The method of claim 1, wherein the notifying step notifies the parties via at least one of an email, a telephone call, a page and an Instant Message.

3. The method of claim 1, further comprising:
displaying a graphical user interface to the parties including information about the conference call.

4. The method of claim 3, wherein the information about the conference call includes a list of the conference calls the respective party has been notified about, and a status section including a status of each respective conference call.

5. The method of claim 4, wherein the status section includes graphical inputs allowing the party to respond to the notification of the conference call, to retrieve detailed information about each respective conference call, and to delete a respective conference call from the graphical user interface, and includes a status field indicating whether or not the respective conference call has been completed.

6. The method of claim 5, wherein when the party selects the graphical input to retrieve the detailed information, the method displays a window including names and contact information about parties notified about the conference call, and a status window indicating status information about each party.

7. The method of claim 6, wherein the status window includes a first field indicating whether or not a respective party has responded to the notification, and a second field indicating whether or not the respective party is going to attend the conference call.

8. The method of claim 7, wherein the second field is updated to indicate the respective party is going to attend the conference call if the authenticating step successfully authenticates the respective party.

9. The method of claim 1, wherein the authentication step either 1) prompts a responding party to enter at least one of an identification and a password and compares the identification and the password with previously stored data to determine whether or not the responding party is successfully authenticated, or 2) uses voice recognition techniques to determine whether or not the responding party is successfully authenticated.

10. The method of claim 1, wherein the determining step is activated when an exceptional unplanned event occurs so as to require the conference call.

11. The method of claim 10, wherein the exceptional unplanned event is the malfunctioning of a local area network (LAN), and wherein the determined parties include those people associated with the task of repairing the LAN.

12. A conference calling system, comprising:
a determining mechanism configured to determine parties to be joined into a conference call;
a notifying server configured to notify the parties about the conference call;
an authenticating server configured to authenticate parties that responded to the notification about the conference call; and
a conference bridging server configured to bridge the parties that have been successfully authenticated into the conference call.

13. The system of claim 12, wherein the notifying server notifies the parties via at least one of an email, a telephone call, a page and an Instant Message.

14. The system of claim 12, further comprising:
a graphical user interface including information about conference calls a respective party has been notified about.

15. The system of claim 14, wherein the information about the conference call includes a list of the conference calls the respective party has been notified about, and a status section including a status of each respective conference call.

16. The system of claim 15, wherein the status section includes graphical inputs allowing the party to respond to the notification of the conference call, to retrieve detailed information about each respective conference call, and to delete a respective conference call from the graphical user interface, and includes a status field indicating whether or not the respective conference call has been completed.

17. The system of claim 16, wherein when the party selects the graphical input to retrieve the detailed information, the graphical user interface displays a window including names and contact information about parties notified about the conference call, and a status window indicating status information about each party.

18. The system of claim 17, wherein the status window includes a first field indicating whether or not a respective party has responded to the notification, and a second field indicating whether or not the respective party is going to attend the conference call.

19. The system of claim 18, wherein the second field is updated to indicate the respective party is going to attend the conference call if the authenticating server successfully authenticates the respective party.

20. The system of claim 12, wherein the authentication server either 1) prompts a responding party to enter at least one of an identification and a password and compares the identification and the password with previously stored data to determine whether or not the responding party is successfully authenticated, or 2) uses voice recognition techniques to determine whether or not the responding party is successfully authenticated.

21. The system of claim 12, wherein the determining mechanism is activated when an exceptional unplanned event occurs so as to require the conference call.

22. The system of claim 21, wherein the exceptional unplanned event is the malfunctioning of a local area network (LAN), and wherein the determined parties include those people associated with the task of repairing the LAN.

23. A computer program embodied on a computer-readable medium for executing instructions on a computer, comprising:
a first computer code configured to determine parties to be joined into a conference call;
a second computer code configured to notify the parties about the conference call;
a third computer code configured to authenticate parties that responded to the notification about the conference call; and
a fourth computer code configured to bridge the parties that have been successfully authenticated into the conference call.

24. The computer program of claim 23, further comprising:
a fifth computer code configured to display a graphical user interface including information about conference calls that a respective party has been notified about,
wherein the information about the conference call includes a list of the conference calls the respective party has been notified about, and a status section including a status of each respective conference call,
wherein the status section includes graphical inputs allowing the party to respond to the notification of the conference call, to retrieve detailed information about each respective conference call, and to delete a respective conference call from the graphical user interface, and includes a status field indicating whether or not the respective conference call has been completed, and
wherein when the party selects the graphical input to retrieve the detailed information, the fifth computer code causes the display of a window including names and contact information about parties notified about the conference call, and a status window indicating status information about each party.

25. The computer program of claim 24, wherein the status window includes a first field indicating whether or not a respective party has responded to the notification, and a second field indicating whether or not the respective party is going to attend the conference call, and
wherein the second field is updated to indicate the respective party is going to attend the conference call if the third computer code successfully authenticates the respective party.

26. The computer program of claim 23, wherein the first computer code is activated when an exceptional unplanned event occurs so as to require the conference call.

27. The computer program of claim 26, wherein the exceptional unplanned event is the malfunctioning of a local area network (LAN), and wherein the determined parties include those people associated with the task of repairing the LAN.
